(19) United States
(12) Patent Application Publication
(10) Pub. No.: US 2007/0034086 A1
(43) Pub. Date: Feb. 15, 2007

(54) Beverage brewing devices having moveable reservoirs

(75) Inventors: Benjamin Arne Colman, Rolleston (GB); Christopher Randall Beharry, Terrace, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/502,989

(22) Filed: Aug. 11, 2006

Related U.S. Application Data
(60) Provisional application No. 60/707,274, filed on Aug. 11, 2005.

(51) Int. Cl. A47J 31/00

(52) U.S. Cl. 99/279

(57) ABSTRACT

Beverage brewing devices generally having a brewing unit for dispensing a beverage, the brewing unit having a longitudinal axis; and a reservoir for storing a liquid, wherein the reservoir is rotatably moveable about the longitudinal axis of the brewing unit when the reservoir is operably connected to the brewing unit.

### CROSS REFERENCE TO RELATED APPLICATIONS

This application claims the benefit of U.S. Provisional Application No. 60/707,274 filed Aug. 11, 2005.

### FIELD OF THE INVENTION

The present invention generally relates to beverage brewing devices comprising moveable reservoirs.

### BACKGROUND OF THE INVENTION

Beverage brewing devices, such as coffee makers, are commonplace in a majority of households today. Consumers enjoy the ease and convenience of brewing their favorite beverages when they want, without having to leave their homes.

Conventional, multi-cup brewing devices have been available to consumers for many years and are generally known to most consumers. Until recently, such brewing devices were the only option available to consumers looking to prepare freshly brewed beverages at home, rather than going to the local coffee house or convenience store to purchase them.

Though multi-cup brewing devices have been on the market for many years, they are not without issue. For instance, the reservoir of most multi-cup brewing devices is embedded within the brewing device, and generally located towards the back. Not only are such reservoirs often hard to access, but they may also be difficult to see and challenging to clean properly. Additionally, many conventional brewing devices take up too much space. Such brewing devices often end up being bulky and awkwardly shaped as they try to incorporate all of the needed elements into one device. Furthermore, due to differences in countertop orientation, not all conventional brewing devices fit in desired locations in consumers' kitchens and often must be situated at an angle for accessibility during use. For example, when preparing coffee, it is necessary for the consumer to be able to access, as well as view, the water reservoir. Accessing the water reservoir allows the consumer to fill the reservoir for brewing while viewing the reservoir allows the consumer to see the existing water level. Due to the configuration of many brewing devices, (i.e. reservoir embedded in the back of the brewing device) these are often difficult tasks.

Another brewing device recently introduced to the market is the single-cup brewing device, which differs from the conventional multi-cup brewing device in that the single-cup brewing device generally provides one cup of brewed beverage at a time. Additionally, single-cup brewing devices differ from espresso brewers in that single-cup brewing devices may be capable of brewing more than just espresso. Usually, single-cup brewing devices are designed to work in conjunction with pre-packaged pods, pouches or cartridges containing brewing materials, and in particular, beverage brewing materials such as coffee, tea, cocoa, dairy-based materials, fruit-based/flavored materials, and the like. Typically, a pod containing the extractable material is placed into the brewing device and within less than two minutes, a single-serving of freshly brewed beverage is produced.

However, with this recent interest in single-cup brewing devices, there is an even greater need for consumers to easily view the water reservoir to determine how much water is present. More particularly, because the water reservoirs of most single-cup brewing devices hold a limited amount of water, often only enough to brew one, or possibly two, cups of coffee, it is important that the consumer is able to easily view the reservoir to be certain there is enough water present to properly brew the beverage. Furthermore, this smaller reservoir size means that the reservoir will likely be refilled with greater frequency than that of conventional brewing devices. Thus, easy access to, and visibility of, the reservoir can increase consumer satisfaction.

Finally, similar to conventional brewing devices, many single-cup brewing devices have the reservoir embedded into the brewing device itself. As previously stated, such a configuration makes it difficult, if not impossible, to clean the reservoir, and thereby increases the likelihood that the reservoir may foster unwanted microbial growth, which in some instances, may not even be noticeable to the consumer.

Therefore, there remains a need for a brewing device having a moveable reservoir so that the device may be conveniently situated on a countertop in a variety of positions to provide easy access to, viewing and handling of, the water reservoir. Additionally, removably connecting the reservoir the brewing device to allow refilling and cleaning is desirable.

### SUMMARY OF THE INVENTION

Embodiments of the present invention relate to a beverage brewing device comprising a brewing unit for dispensing a beverage, the brewing unit having a longitudinal axis; and a reservoir for storing a liquid, wherein the reservoir is rotatably moveable about the longitudinal axis of the brewing unit when the reservoir is operably connected to the brewing unit.

In another aspect, embodiments of the present invention relate to a beverage brewing device comprising a brewing unit for dispensing a beverage, the brewing unit having a dually convex shape; and a reservoir for storing a liquid, the reservoir having a dually concave shape that is substantially complementary to the dually convex shape of the brewing unit.

In yet another aspect, embodiments of the present invention relate to a beverage brewing device comprising a brewing unit for dispensing a beverage, the brewing unit having a longitudinal axis; a base wherein the base is rotatably movable about the longitudinal axis of the brewing unit; and a power cable operably connected to the base such that the power cable does not interfere with rotation of the reservoir.

### BRIEF DESCRIPTION OF THE DRAWINGS

FIG. 1 is a schematic perspective view of one embodiment of a beverage brewing device in accordance with the present invention.

FIG. 2 is a schematic front view of one embodiment of a beverage brewing device having a reservoir positioned to the right of the brewing unit in accordance with the present invention.

FIG. 3 is a schematic top view of one embodiment of a beverage brewing device having a reservoir positioned to the right of the brewing unit in accordance with the present invention.

FIG. 4 is a schematic front view of one embodiment of a beverage brewing device having a reservoir positioned to the left of the brewing unit in accordance with the present invention.

FIG. 5 is a schematic top view of one embodiment of a beverage brewing device having a reservoir positioned to the left of the brewing unit in accordance with the present invention.

FIG. 6 is a schematic perspective view of one embodiment of a base and plate in accordance with the present invention.

FIG. 7 is a schematic perspective view of one embodiment of a reservoir operably connected to a base in accordance with the present invention.

FIG. 8 is a schematic perspective view of one embodiment of a bottom of a reservoir in accordance with the present invention.

FIG. 9 is a schematic perspective view of one embodiment of an exterior of a rear shell with attached plate in accordance with the present invention.

FIG. 10 is a schematic perspective view of one embodiment of an interior of a rear shell with attached plate in accordance with the present invention.

FIG. 11 is a schematic perspective view of one embodiment of an underside of a rear shell in accordance with the present invention.

FIG. 12 is a schematic perspective view of one embodiment of a reservoir in accordance with the present invention.

FIG. 13 is a schematic side view of one embodiment of a brewing unit and base in accordance with the present invention.

FIG. 14 is a schematic perspective top view of one embodiment of a beverage brewing device in accordance with the present invention.

FIG. 14A is an enlarged schematic view of a portion of FIG. 14.

### DETAILED DESCRIPTION OF THE INVENTION

A. Definitions

As used herein, the term “beverage brewing device” means a conventional, multi-cup brewing device or a single-cup brewing device, having a moveable spout.

As used herein, the term “comprising” means various components can be co-jointly employed in the methods and articles of this invention. Accordingly, the terms “consisting essentially of” and “consisting of” are embodied in the term comprising.

As used herein, the term “extractable material” means any solid, liquid, powder or concentrate that may be extracted, dissolved or diluted to produce a consumable liquid. In one embodiment, the “extractable material” may be an “extractable beverage material,” which includes, but is not limited to, coffee (including, but not limited to, roast and ground, latte, cappuccino and espresso), tea, cocoa, dairy-based materials and/or fruit-based/flavored materials.

As used herein, the term “extracting” or “to extract” may not only mean to treat with a solvent so as to remove a soluble substance, but also may include dissolving or diluting extractable materials as defined herein.

As used herein, the term “liquid extract” means a consumable liquid derived from any solid, liquid, powdered or concentrated extractable material, as defined herein.

B. Beverage Brewing Devices

As previously mentioned, embodiments of the present invention relate to beverage brewing devices that improve the ease and convenience of use by providing consumers with the ability to selectively position the reservoir about the brewing unit, as well as optionally remove the reservoir for refilling and cleaning.

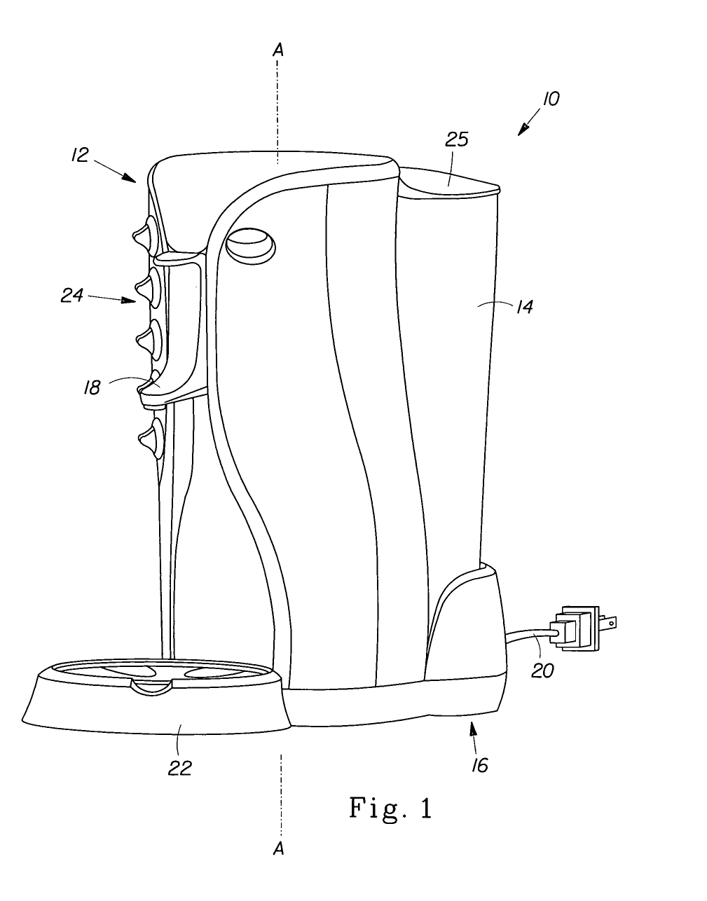

Referring to the drawings wherein like numerals relate to similar features throughout the drawings, FIG. 1 illustrates an embodiment of beverage brewing device 10, which generally comprises a brewing unit 12 having a longitudinal axis A-A and a reservoir 14 that may be operably connected to brewing unit 12 via a base 16. Reservoir 14 may be rotatably moveable about brewing unit 12 via base 16, as further explained herein below. Brewing unit 12 may further optionally comprise a spout 18, a power cable 20, a drip tray 22 and one or more operation buttons 24 and lights (not shown). Beverage brewing device 10 may be a multi-cup brewing device, or, as illustrated in the exemplary drawings, may comprise a single-cup brewing device. While the following description may focus on coffee and coffee beverages, and a single-cup brewing device, it will be understood that such references are for illustration purposes only and the description should not be limited to such beverage or devices.

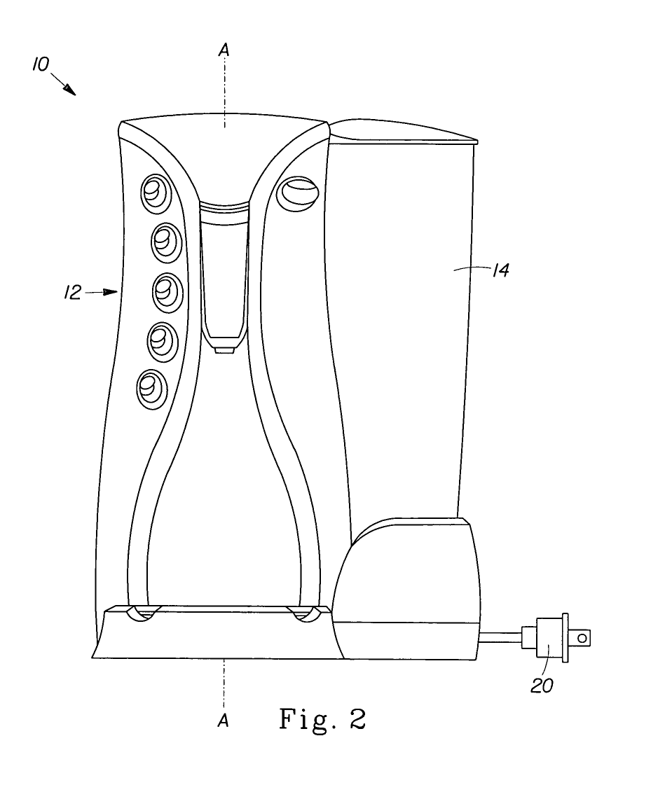

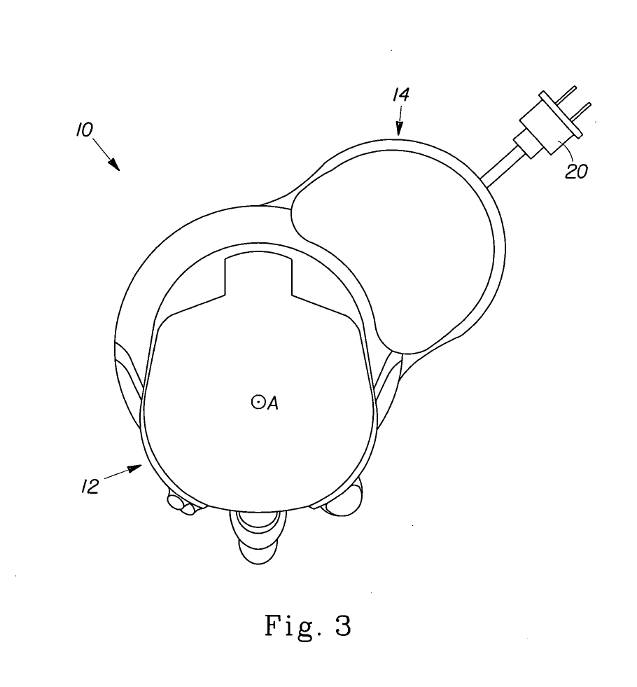

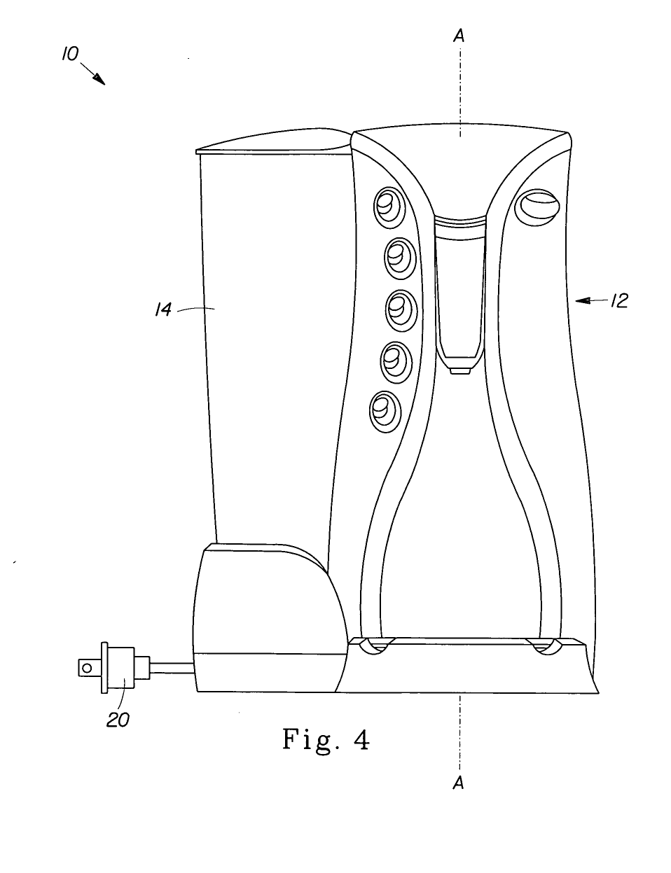

As previously discussed, reservoir 14 may be rotatably connected to brewing unit 12 via a base 16. In one embodiment, reservoir 14 may be positioned directly behind brewing unit 12. However, because reservoir 14 may be rotatably moveable about a longitudinal axis A-A of brewing unit 12, reservoir 14 may be rotated to the right of brewing unit 12 (as shown in FIGS. 2 and 3) or to the left of brewing unit 12 (as shown in FIGS. 4 and 5). It is contemplated that reservoir 14 may be rotated less than about 270 degrees about longitudinal axis A-A of brewing unit 12 (i.e. from one side of brewing unit 12 to the other). In another embodiment, it is contemplated reservoir 14 may be rotated less than about 180 degrees, and in yet another embodiment, from about 100 degrees to about 160 degrees, about longitudinal axis A-A. In another embodiment, reservoir 14 may be rotated at any angle about brewing unit 12 that allows for operability of the brewing device as described herein.

By providing the consumer with the option of rotating reservoir 14 about longitudinal axis A-A of brewing unit 12, the consumer may position reservoir 14 in a position that best suits the consumer's needs. For instance, if a consumer wishes to place beverage brewing device 10 in a narrow area, the consumer may choose to position reservoir 14 directly behind brewing unit 12 to minimize the overall width of brewing device 10. If, however, a consumer wishes to be able to view reservoir 14 at all times, the consumer may rotate reservoir 14 by rotating base 16 to move reservoir 14 to the right or left side of brewing unit 10 such that reservoir 14 may be easily seen.

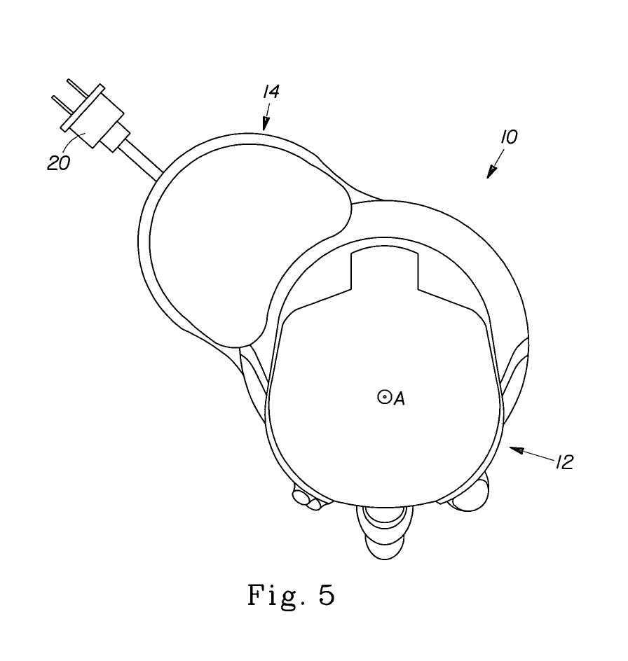

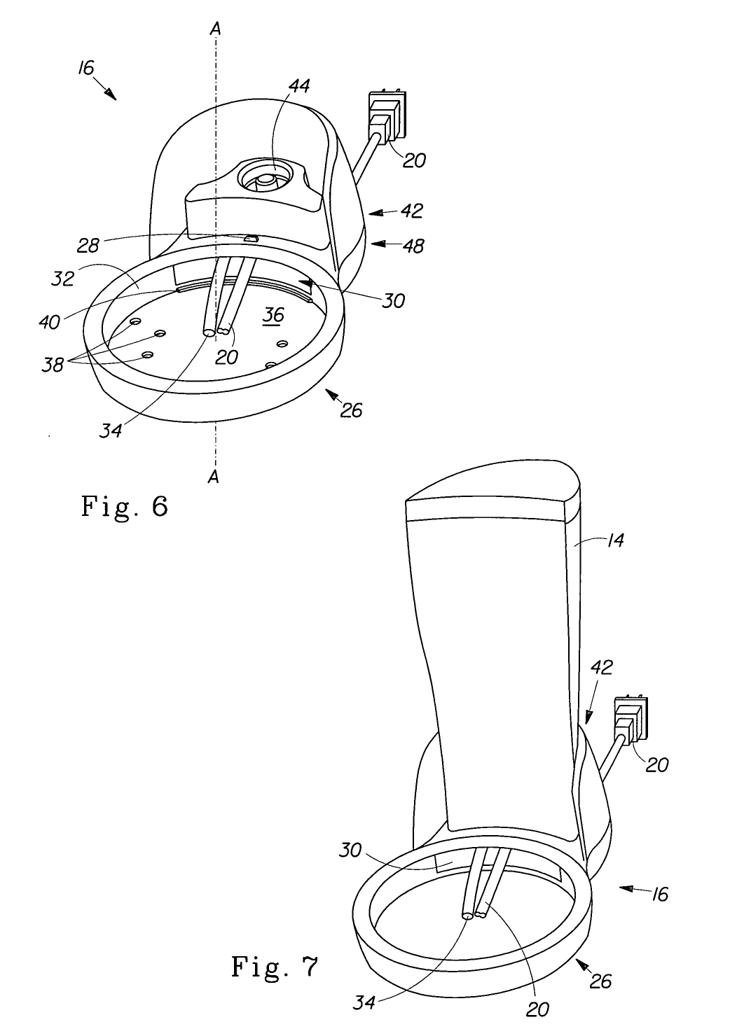

FIGS. 6, 7 and 8 illustrate base 16 and reservoir 14, as well as exemplary components for connection there between. Turning to FIGS. 6 and 7, as previously discussed, the brewing device comprises a base 16 that may operably connect reservoir 14 to the brewing unit such that reservoir 14 may be in liquid communication with the brewing unit. Base 16 may comprise a collar portion 26 and a cradle 42. Collar portion 26 of base 16 may be slidably associated with and optionally circumscribe brewing unit 12 (as shown in FIG. 1) and may be rotatably movable about longitudinal axis A-A of brewing unit 12. Collar portion 26 may further comprise a tab 28 to aid in limiting the rotation of reservoir 14 about longitudinal axis A-A (explained herein below). Moreover, collar portion 26 may comprise an opening, preferably a slit 30, through an inner wall 32, through which a tube 34 may extend to transfer liquid from reservoir 14 to the brewing unit. Slit 30 may be of sufficient size to accommodate tube 34 (and power cable 20 as explained herein below) but not so large as to permit extraneous shifting of tube 34 which may compromise the integrity and/or operability thereof. While collar portion 26 is shown to be completely circular, and have an inner wall 32, other arrangements are also possible.

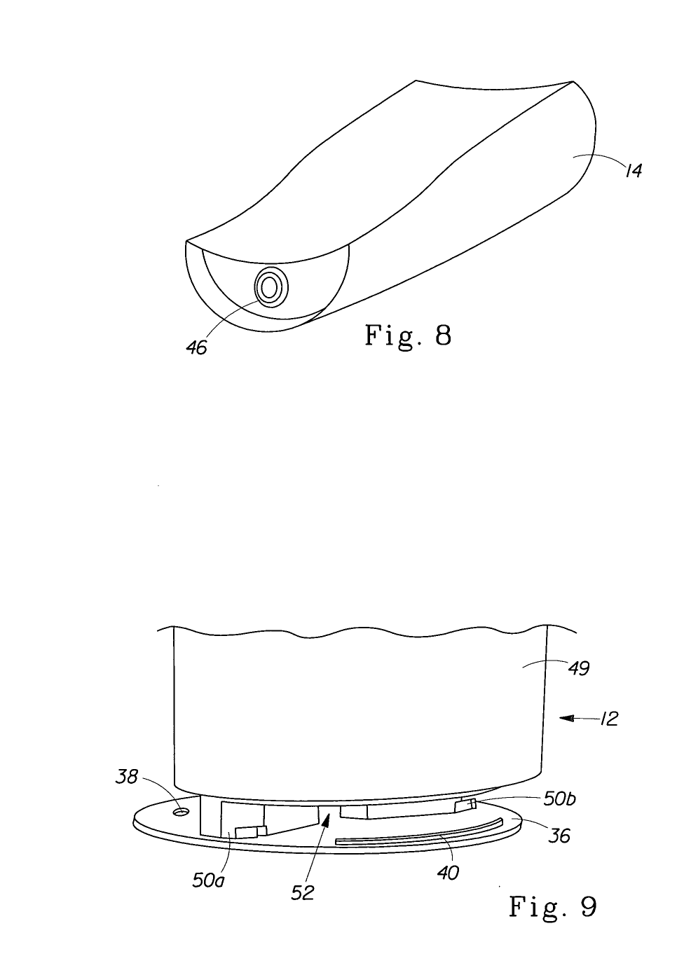

As previously discussed, base 16 may further comprise a cradle 42 to support reservoir 14, as well as help retain reservoir 14 in a position substantially adjacent to the brewing unit. Cradle 42 may comprise an inlet 44 to allow the brewing unit to be in liquid communication with a corresponding outlet 46 (see FIG. 8) of reservoir 14 when reservoir 14 is operably connected to the brewing unit via base 16. Such liquid communication may be direct or indirect liquid communication. Direct liquid communication may be desired when reservoir 14 is not removable from base 16 as it allows the liquid to freely pass from reservoir 14 to base 16 if reservoir 14. Indirect liquid communication may be desired when reservoir 14 is removable from base 16 as it provides a barrier (e.g. a check valve (not shown)) to the passage of the liquid from reservoir 14 to base 16, such that when reservoir 14 is removed from base 16, liquid present in reservoir 14 will not leak from reservoir 14.

Removably connecting reservoir 14 to base 16 provides several benefits. First, reservoir 14 may be removed from the beverage brewing device for refilling, which allows the consumer to see how much water he or she is adding to reservoir 14 and helps ensure the proper amount of water is present. Second, a removable reservoir 14 allows a consumer to easily clean reservoir 14, which helps keep the brewing device sanitary.

A plate 36 may be received beneath collar portion 26 of base 16 and may be optionally fixedly connected to the brewing unit by fasteners (not shown) that protrude through holes 38 in plate 36 into the brewing unit, thereby supporting the brewing unit. Plate 36 may further comprise a guide 40 such that, when plate 36 is operably received by collar portion 26 of base 16, guide 40 may be flush with inner wall 32 of collar portion 26. This configuration helps to not only hold collar portion 26 of base 16 in place, but also aids in directing the movement of collar portion 26 of base 16 as collar portion 26 slidably rotates about the brewing unit relative to plate 36.

As previously mentioned, base 16 may further comprise power cable 20 for supplying electricity to the beverage brewing device. Placement of power cable 20 on collar portion 26 of base 16 can allow power cable 20 to be rotated about longitudinal axis A-A in conjunction with rotation of collar portion 26 of base 16 and reservoir 14. More specifically, power cable 20 may extend from a back section 48 of collar portion 26 and through slit 30 along with tube 34 so that power cable 20 does not interfere with rotation of reservoir 14. The ability to rotate power cable 20 about the brewing unit allows power cable 20 to not only be conveniently positioned for use, but also to be situated in an aesthetically pleasing location.

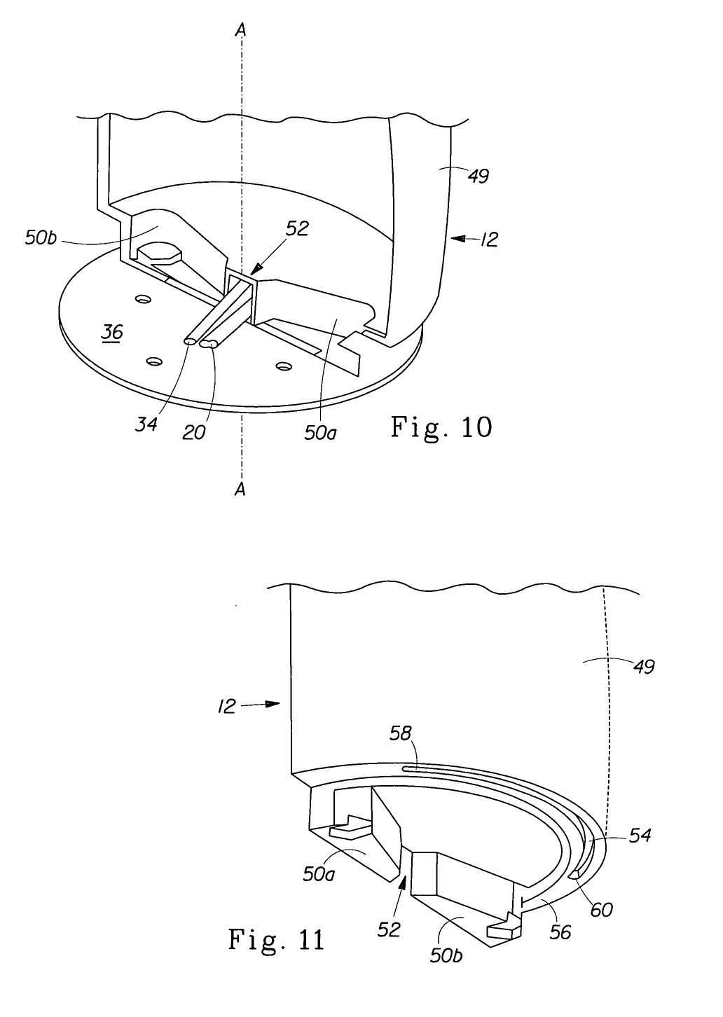

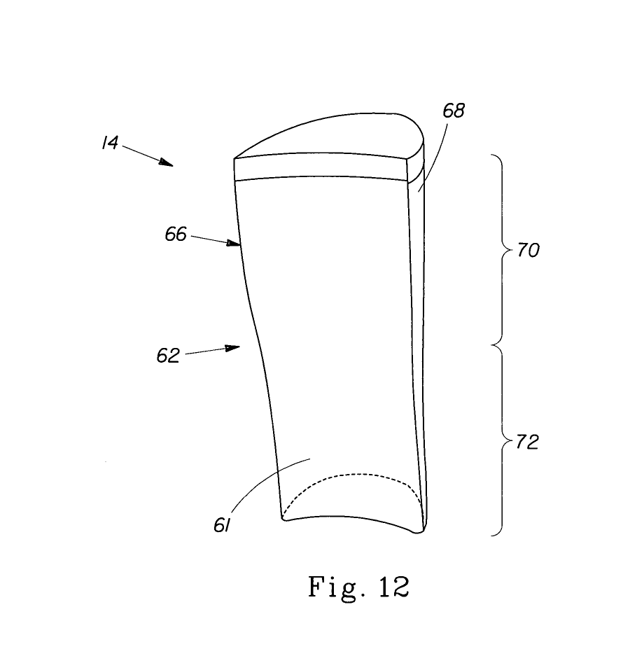

Turning to FIGS. 9, 10 and 11, a rear shell 49 of brewing unit 12 may comprise legs 50a and 50b, as well as a passage 52 and a groove 54, all of which aid in rotation of collar portion 26 of base 16. Legs 50a and 50b may provide support to brewing unit 12, as well as help direct tube 34 and power cable 20 to a desired position between legs 50a and 50b and through passage 52 for attaching to brewing unit 12. Particularly, legs 50a and 50b may be situated such that passage 52 is located at about longitudinal axis A-A of brewing unit 12. By positioning passage 52 in this manner, tube 34 and power cable 20 may remain substantially equidistant to inlet 44 and back section 48 of collar portion 26, respectively, during rotation. This helps prevent tangling or twisting of tube 34 and/or power cable 20, which could interfere with rotation or liquid communication. Passage 52 should be of sufficient size to accommodate tube 34 and power cable 20, but not so large as to permit extraneous shifting of tube 34 and power cable 20, which may compromise the integrity and/or operability of tube 34 and power cable 20.

Also helping with rotation is groove 54, which may be located in a lip 56 of rear shell 49 and which has a first end 58 and a second end 60. When rear shell 49 is operably connected to the base, tab 28 (shown in FIG. 6) may be received by groove 54. Rotation of the base can be limited as the tab rotates between first end 58 and second end 60 of groove 54. One skilled in the art will understand that the location of tab 28 and groove 54 may be inverted such that tab 28 may extend from rear shell 49 while groove 54 may be positioned in the base. The length of groove 54 and the placement of legs 50a and 50b may be such that, as previously discussed, tube 34 and power cable 20 may remain substantially equidistant from the inlet of the cradle and the back section of the collar portion, respectively, throughout rotation, thereby preventing tangling or twisting that could interfere with rotation and or/operability.

It will be understood that the foregoing description is an exemplary embodiment illustrating one assembly that may be used to rotate the reservoir and base and should not be limited to such. In general, any assembly that provides for rotation of the reservoir about the brewing unit without tangling, twisting or otherwise compromising the function of the tube and/or power cable, is acceptable for use herein.

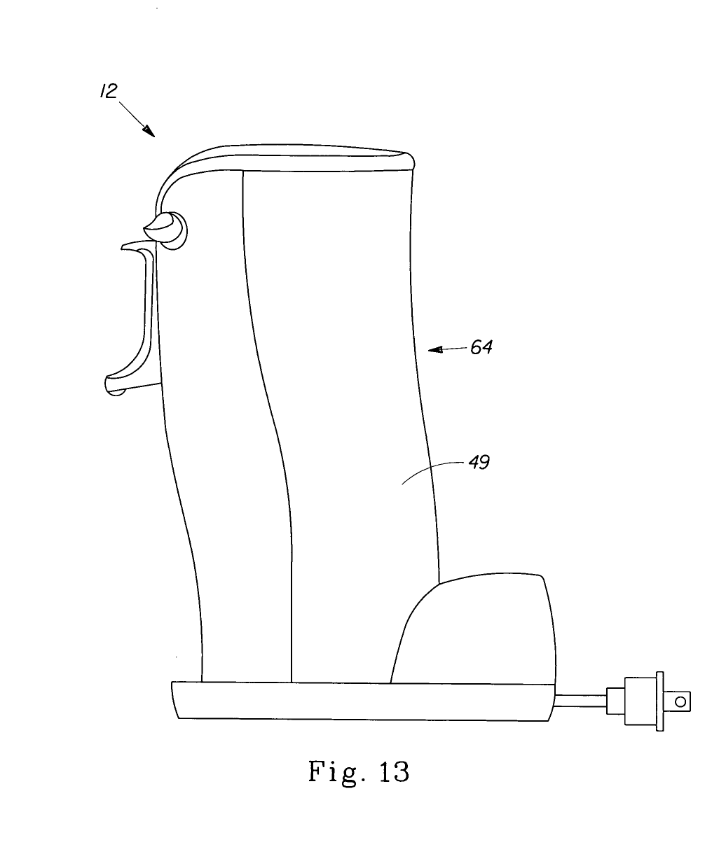

As illustrated in FIG. 12, reservoir 14 may comprise a surface 61 having a dually concave shape 62, which may not only be substantially complementary to, or nestable in, a dually convex shape 64 of rear shell 49 of brewing unit 12 (as shown in FIG. 13) to allow for rotation relative thereto, but also may aid in the manageability of the reservoir itself. Reservoir 14 can comprise vertical concavity, as well as horizontal concavity. More specifically, reservoir 14 may comprise a first side 66 and a second side 68, wherein reservoir 14 is curved inwardly between first side 66 and second side 68. Likewise, reservoir 14 may comprise an upper portion 70 and a lower portion 72, wherein at least a portion of reservoir 14 curves inwardly between upper portion 70 to lower portion 72, and in one embodiment, reservoir 14 curves inwardly from upper portion 70 to lower portion 72. The horizontal concavity between first side 66 and second side 68, in conjunction with the aforementioned vertical concavity from upper portion 70 to lower portion 72, may result in upper portion 70 of reservoir 14 occupying a greater area than lower portion 72 of reservoir 14. By upper portion 70 generally being larger than lower portion 72, the ease of handling reservoir 14 is improved because lower portion 72 is smaller and simpler to grasp and manage. Moreover, dually concave shape 62 of surface 61 of reservoir 14 may contribute to the overall aesthetic appeal of the brewing device.

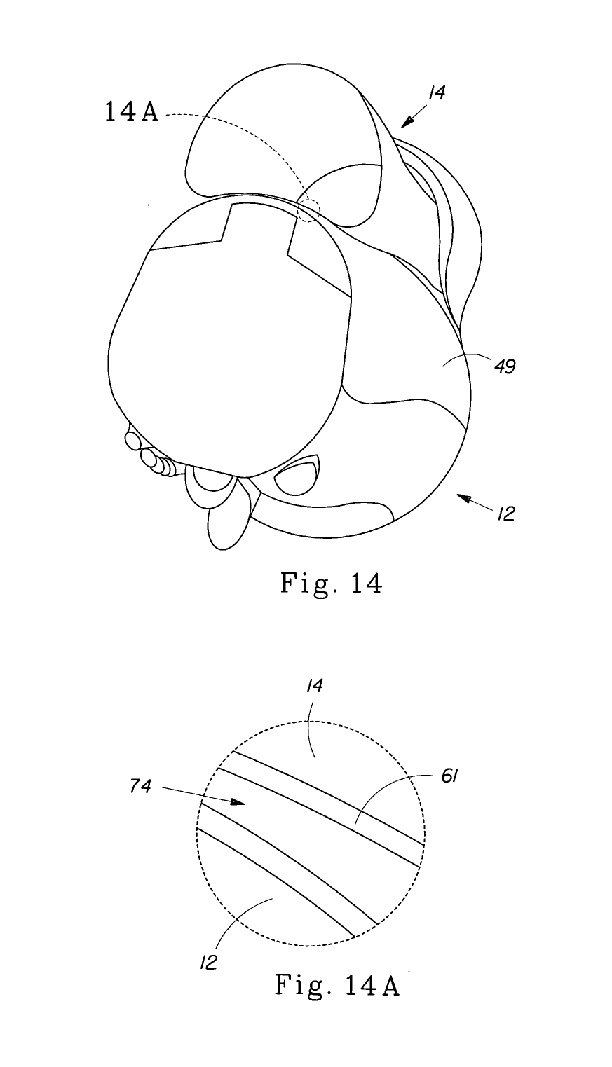

Turning to FIG. 14, in an effort to make the brewing device compact while maintaining a high degree of functionality, when reservoir 14 is filled with a liquid and operably connected to brewing unit 12, a gap 74 of less than about 20 mm may be present between at least a portion of surface 61 of reservoir 14 having a dually concave shape and rear shell 49 of brewing unit 12 which comprises a substantially complementary dually convex shape. Having a gap 74 of this size helps keep reservoir 14 in close proximity to brewing unit 12, yet still provides enough space between reservoir 14 and brewing unit 12 to smoothly rotate reservoir 14 about brewing unit 12. In an alternate embodiment, gap 74 may be from about 1 mm to about 10 mm. Of course, it should be understood that any gap between surface 61 of reservoir 14 and rear shell 49 of brewing unit 12, may be greater or less depending on the overall size of the beverage brewing device.

Furthermore, at least a portion of the reservoir may be translucent or transparent. Translucence or transparency further aids in allowing the consumer to view the amount of water present in the reservoir. Of course, any translucent or transparent material is acceptable for use herein, including, but not limited to, plastic or glass or other like material.

It will be understood that embodiments of the brewing devices described herein may comprise additional components known in the art to be common to many conventional brewing devices but not shown in the present illustrations, including, but not limited to, internal components such as a heater, pump and control system, as well as further optional components, such as a brew basket, pod holder (when applicable) and closing mechanism. Furthermore, embodiments of brewing device, as well as components thereof described herein, may be constructed of a variety of materials known in the art, including, but not limited to, plastics, metals and the like. Those skilled in the art will understand how to select the optimum material for constructing the various components based on each component's function.

Use of the brewing device may be carried out as explained herein below. Extractable material, optionally packaged in a pod or pouch, may be placed into a brew basket of the brewing unit and the power cable can be plugged into an electrical outlet to provide electricity to the brewing device. A consumer can rotate the reservoir to a desired position about the brewing unit by rotating the base to that position so that liquid can be added or so that the existing liquid level can be checked. Next, the consumer may select which size beverage is desired by activating the corresponding operation button for that beverage size. At the initiation of the brewing cycle, liquid from the reservoir is drawn through the outlet of the reservoir, through the inlet of the cradle of the base and into the tube. The tube carries the liquid through the slit in the collar portion of the base to the brewing unit where it travels through a heater and is dispensed, generally under pressure, onto the pod containing the extractable material. As the liquid passes through the pod, the resulting extract ultimately travels from the brew basket through to the spout and exits the brewing device via a dispensing orifice in the spout where it can be collected in the consumer's cup.

It will be understood that embodiments of the brewing devices described herein may comprise additional components common to many conventional brewing devices but not shown in the present illustrations, including, but not limited to, internal components such as a heater, pump and control system, as well as further optional components, such as a brew basket, pod holder (when applicable) and closing mechanism. Furthermore, embodiments of brewing device, as well as components thereof described herein, may be constructed of a variety of materials known in the art, including, but not limited to, plastics, metals and the like. Those skilled in the art will understand how to select the optimum material for constructing the various components based on each component's function.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A beverage brewing device comprising:
a brewing unit for dispensing a beverage, the brewing unit having a longitudinal axis; and
a reservoir for storing a liquid, wherein the reservoir is rotatably moveable about the longitudinal axis of the brewing unit when the reservoir is operably connected to the brewing device.

2. The beverage brewing device of claim 1 wherein the reservoir is in liquid communication with the brewing unit when the reservoir is operably connected to the brewing device.

3. The beverage brewing device of claim 1 wherein the reservoir is rotatably movable about the longitudinal axis of the brewing unit by less than about 270 degrees.

4. The beverage brewing device of claim 1 wherein the reservoir is removably connected to the brewing device.

5. The beverage brewing device of claim 1 wherein the reservoir is rotatably movable about the longitudinal axis of the brewing unit by from about 100 degrees to about 180 degrees.

6. The beverage brewing device of claim 1 further comprising a base for holding the reservoir, wherein the base is rotatably movable about the longitudinal axis of the brewing unit when operably connected.

7. The beverage brewing device of claim 1 wherein at least a portion of the reservoir is translucent.

8. The beverage brewing device of claim 6 further comprising a power cable operably connected to the base such that the power cable does not interfere with rotation of the reservoir.

9. The beverage brewing device of claim 1 wherein the brewing device is a single-cup brewing device.

10. The beverage brewing device of claim 6 wherein the base further comprises a collar portion, the collar portion being rotatably moveable about the brewing unit.

11. A beverage brewing device comprising:
a brewing unit for dispensing a beverage, the brewing unit having a rear shell having a dually convex shape; and
a reservoir for storing a liquid, the reservoir having a surface having a dually concave shape that is substantially complementary to the dually convex shape of the rear shell of the brewing unit.

12. The beverage brewing device of claim 11 wherein the brewing unit further comprises a longitudinal axis wherein the reservoir is rotatably movable about the longitudinal axis of the brewing unit when the reservoir is operably connected to the brewing unit.

13. The beverage brewing device of claim 11 wherein the reservoir is rotatably movable about the longitudinal axis of the brewing unit by about 270 degrees.

14. The beverage brewing device of claim 11 wherein a gap of less than about 20 mm is present between at least a portion of the surface of the reservoir having a dually concave shape and the substantially complementary dually convex shape of the rear shell of the brewing unit when the reservoir is operably connected to the brewing device.

15. The beverage brewing device of claim 11 wherein the reservoir is in liquid communication with the brewing unit when the reservoir is operably connected to the device.

16. The beverage brewing device of claim 11 wherein the reservoir is removably connected to the brewing device.

17. The beverage brewing device of claim 14 wherein the gap is from about 1 mm to about 10 mm.

18. The beverage brewing device of claim 11 wherein at least a portion of the reservoir is translucent.

19. A beverage brewing device comprising:
a brewing unit for dispensing a beverage, the brewing unit having a longitudinal axis;
a base wherein the base is rotatably movable about the longitudinal axis of the brewing unit; and
a power cable operably connected to the base such that the power cable does not interfere with rotation of the reservoir.

20. The beverage brewing device of claim 19 wherein the base is rotatably movable about the longitudinal axis of the brewing unit by about 270 degrees.
